(19) United States
(12) Patent Application Publication
(10) Pub. No.: US 2017/0193469 A1
(43) Pub. Date: Jul. 6, 2017

(54) METHOD AND SYSTEM FOR PROVIDING E-INVOICES

(71) Applicant: MasterCard International Incorporated, Purchase, NY (US)

(72) Inventor: Augustine Patrick HERNANDEZ, Miami, FL (US)

(73) Assignee: MasterCard International Incorporated, Purchase, NY (US)

(21) Appl. No.: 14/985,593

(22) Filed: Dec. 31, 2015

(51) Int. Cl. G06Q 20/10; G06Q 20/40

(52) U.S. Cl. CPC G06Q 20/102; G06Q 20/401

(57) ABSTRACT

A method for generating and reporting electronic invoices for a payment transaction includes: storing a plurality of entity data entries, each including data related to a taxable entity including a transaction account number, tax identification number, and entity invoicing data; receiving a transaction message for a payment transaction, the message including a primary account number and transaction data; identifying a specific entity data entry where the included transaction account number corresponds to the primary account number; generating an electronic invoice, wherein the electronic invoice is formatted according to one or more invoicing standards set by a regulatory agency and includes at least the transaction data and the tax identification number and entity invoicing data included in the identified specific entity data entry; and electronically transmitting the generated electronic invoice to at least one of: the regulatory agency and the taxable entity associated with the specific entity data entry.

### FIELD

The present disclosure relates to the generating and reporting of electronic invoices for electronic transactions, specifically the generation of an electronic invoice for a payment transaction that includes details associated with the transaction and taxable entity involved in the transaction for reporting to an associated regulatory agency.

### BACKGROUND

Buyers and sellers involved in electronic transactions rely on invoicing to serve a variety of purposes. Entities will often times use invoices to track purchase and sales for record-keeping, quality assurance, and logistics associated with day-to-day activities of the entity. In many jurisdictions, entities may also be required to provide electronic invoices for transactions to local regulatory agencies, such as governmental tax authorities. In such places, there are often third parties that specialize in the generation of electronic invoices for transactions that can operate on behalf of a buyer or seller to generate and provide the electronic invoices.

However, these third parties often operate using transaction data provided directly from the buyer or seller. As a result, the buyer or seller must still keep track of all of their transactions and the data associated therewith, which is then provided to the electronic invoicing (or “e-invoicing”) third party for use in generating the electronic invoice (or “e-invoice”). Thus, the buyer or seller is still collecting all of the data necessary for the invoicing, with the third party providing little assistance and benefit.

Thus, there is a need for a technical solution whereby a computing system can collect transaction data for payment transactions as they occur, match individual transaction data to previously collected tax or fiscal information of the buyer and/or of the seller, to generate e-invoices based thereon, that can be done without interaction by the buyer or seller for whom the e-invoices are provided. This can result in a significant decrease in expenditure of time and resources for the buyer or seller, and also provide greater accuracy in the e-invoicing data as there is less opportunity for human or system error to be introduced due to the decrease in interaction by the buyer or seller.

### SUMMARY

The present disclosure provides a description of systems and methods for generating and reporting electronic invoices for a payment transaction.

A method for generating and reporting electronic invoices for a payment transaction includes: capturing, through well-defined and secure enrollment processes that use a variety of channels (online and offline), a plurality of entity data entries; storing, in an entity database of a processing server, this plurality of entity data entries, wherein each entity data entry includes data related to a taxable entity including at minimum a transactional payment account number, a tax identification number, and entity invoicing data; receiving, by a receiving device of the processing server, an electronically transmitted transaction message for a payment transaction, wherein the transaction message is formatted pursuant to one or more standards and includes a plurality of data elements including at least a first data element configured to store a primary account number and one or more additional data elements configured to store transaction data; executing by a processing device of the processing server, a data matching process through a query on the entity database to identify a specific entity data entry where the included transaction account number corresponds to the primary account number stored in the first data element of the received transaction message; generating, by the processing device of the processing server, an electronic invoice, wherein the electronic invoice is formatted according to one or more invoicing standards set by a regulatory agency and includes at least the transaction data stored in the one or more additional data elements of the received transaction message and the tax identification number and entity invoicing data included in the identified specific entity data entry; and electronically transmitting, by a transmitting device of the processing server, the generated electronic invoice to at least one of: the regulatory agency and the taxable entity associated with the specific entity data entry.

A system for generating and reporting electronic invoices for a payment transaction includes an entity database, a receiving device, a processing device, and a transmitting device of a processing server. The entity database of the processing server is configured to store a plurality of entity data entries, wherein each entity data entry includes data related to a taxable entity including at least a transaction account number, a tax identification number, and entity invoicing data. The receiving device of the processing server is configured to receive an electronically transmitted transaction message for a payment transaction, wherein the transaction message is formatted pursuant to one or more standards and includes a plurality of data elements including at least a first data element configured to store a primary account number and one or more additional data elements configured to store transaction data. The processing device of the processing server is configured to: execute a query on the entity database to identify a specific entity data entry where the included transaction account number corresponds to the primary account number stored in the first data element of the received transaction message; and generate an electronic invoice, wherein the electronic invoice is formatted according to one or more invoicing standards set by a regulatory agency and includes at least the transaction data stored in the one or more additional data elements of the received transaction message and the tax identification number and entity invoicing data included in the identified specific entity data entry. The transmitting device of the processing server is configured to electronically transmit the generated electronic invoice to at least one of: the regulatory agency and the taxable entity associated with the specific entity data entry.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for generating and reporting electronic invoices for payment transactions in accordance with exemplary embodiments.

FIG. 2 is a block diagram illustrating the processing server of FIG. 1 for generating and reporting electronic invoices in accordance with exemplary embodiments.

FIG. 3 is a flow diagram illustrating a process for the generation and report of an electronic invoice for a payment transaction using the system of FIG. 1 in accordance with exemplary embodiments.

FIG. 4 is a flow chart illustrating a process for the generation and report of an electronic invoice for a payment transaction using the processing server of FIG. 2 in accordance with exemplary embodiments.

FIG. 5 is a flow chart illustrating an exemplary method for generating and reporting electronic invoices for a payment transaction in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Electronic Invoicing of Payment Transactions

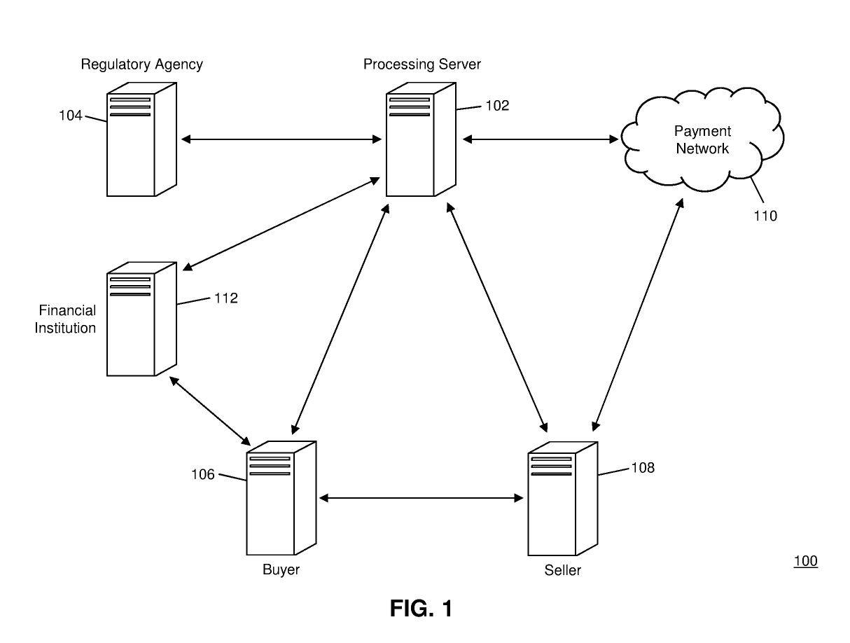

FIG. 1 illustrates a system 100 for the generation and reporting of electronic invoices for payment transactions.

The system 100 may include a processing server 102. The processing server 102, discussed in more detail below, may be configured to generate and report electronic invoices for payment transactions. Electronic invoices may be subject to one or more rules or regulations as provided by a regulatory agency 104. The regulatory agency 104 may be an agency associated with a municipality, state, country, region, etc. that is associated with payment transactions, such as via taxation. The rules or regulations may be set forth regarding the reporting of payment transactions to the regulatory agency 104 and one or more criteria associated therewith. For example, the regulatory agency 104 may be a tax authority that may require the reporting of electronic invoices regarding payment transactions for the auditing of taxation. The rules or regulations may set forth, for instance, requirements on data to be included in electronic invoices provided to the regulatory agency 104. In some embodiments, the regulatory agency 104 may authorize the processing server 102 before the processing server 102 may be able to generate and report electronic invoices to the regulatory agency 104 that are compliant with the rules and regulations.

In the system 100, a buyer 106 may conduct a payment transaction with a seller 108 for the purchase of one or more products (e.g., goods or services). In some instances, the buyer 106 and seller 108 may be a business, corporation, or other similar entity. In other instances, the buyer 106 and/or seller 108 may be an individual or other non-business entity. In some embodiments, the regulatory agency 104 may set rules or regulations regarding what entities (e.g., businesses, non-business entities, etc.) must comply with the rules or regulations and may set different rules or regulations for different entities.

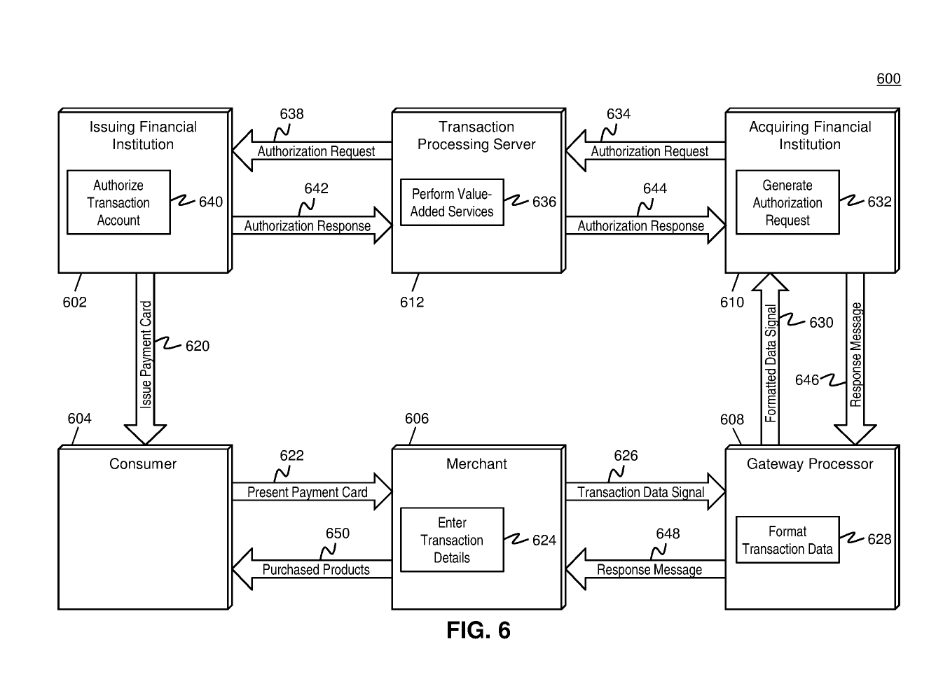

The buyer 106 and seller 108 may conduct a payment transaction for the purchase of one of more goods, which may be processed by a payment network 110. The processing of the payment transaction may include the electronic transmission of transaction data from the seller 108 to the payment network 110 via the payment rails using one or more intermediate processing entities, such as gateway processors or acquiring financial institutions. The transaction data may be provided to the payment network 110 in a transaction message, which may be a specially formatted data message that is formatted based on one or more standards governing the transmission and exchange of financial transaction messages, such as the International Organization of Standardization's ISO 8583 standard. Transaction messages may include, for example, one or more data elements configured to store data associated with the payment transaction as set forth in the associated standard(s), a message type indicator indicative of a type of the transaction message, a bitmap indicative of the data elements included therein and data stored therein, etc. The payment rails, transaction messages, and the submission of transaction data to a payment network 110 for processing is discussed in more detail below with respect to the process 600 illustrated in FIG. 6.

Once the payment network 110 has received the transaction message, the payment network 110 may process the payment transaction using traditional methods and systems. As part of the processing, the payment network 110 may provide a copy of the transaction message for the payment transaction to the processing server 102 for use in electronic invoicing. In some embodiments, the payment network 110 may first identify the buyer 106 or seller 108 as associated with the processing server 102 for electronic invoicing. For example, the processing server 102 may provide transaction account information, such as a primary account number, for the buyer 106, seller 108, and any other entity for whom the processing server 102 is authorized to provide electronic invoices, to the payment network 110. The payment network 110 may identify if the transaction data in the transaction message corresponds to the transaction account information provided by the processing server 102, and may provide the transaction message to the processing server 102. In other embodiments, the transaction message may be provided directly to the processing server 102 by the payment network 110 without filtering, whereby the processing server 102 may identify if an electronic invoice is to be generated for any entity involved, such as based on primary account numbers included in the transaction message.

In some embodiments, the processing server 102 may be included in the computing system or systems of the payment network 110. In such instances, the processing server 102 may receive the transaction message as part of the processing of the payment transaction (e.g., as directly from the seller 108 or entity associated therewith) or may receive the transaction message via internal communication of the payment network 110. In some instances, the processing server 102 may be configured to process the payment transaction using traditional methods and systems, and may retain the transaction message as a result of the processing for use in electronic invoicing.

In some embodiments, the payment network 110 may electronically transmit transaction messages to the processing server 102 via the payment rails. In other embodiments, the transaction messages may be electronically transmitted using a suitable alternative communication network. In some cases, the transaction messages may be authorization requests and/or responses for payment transactions being authorized. In other cases, the transaction messages may be clearing records for previously processed payment transactions. As discussed in more detail below, the generating and reporting of an electronic invoice for the payment transaction may be based on the type of transaction message received by the processing server 102. The type of the transaction message may be determined based on the message type indicator included therein.

When the processing server 102 receives a transaction message for a payment transaction, the processing server 102 may identify data associated with a taxable entity involved therein. For example, the buyer 106 may register with the processing server 102 for electronic invoicing, and may provide the processing server 102 with at least a transaction account number, a tax identification number, and additional invoicing data. Registration may include the electronic transmission of data from one or more computing devices or systems of the buyer 106 to the processing server 102 using a suitable communication network, such as the Internet, a cellular communication network, a radio frequency network, a local area network, etc. The transaction account number may be used in the identification of transaction messages involving the buyer 106. The tax identification number may be used in the identification of the buyer 106 by the regulatory agency 104. The additional invoicing data may be additional data associated with the buyer 106 as may be required in the rules or regulations set forth by the regulatory agency 104. For instance, the additional invoicing data may include the buyer's name, the buyer's address, an industry or category code, etc.

Once the processing server 102 has identified data associated with the buyer 106 (e.g., and/or seller 108) involved in the payment transaction, the processing server 102 may generate an electronic invoice. The electronic invoice may include at least the tax identification number and additional invoicing data associated with the buyer 106. In some instances, the electronic invoice may also include data associated with the processing server 102, such as data required by the regulatory agency 104 to provide the identity and authenticity of the processing server 102 as authorized to report electronic invoices, such as a certification number, seal, etc. The format and content of data included in the electronic invoice may be based on the one or more rules set forth by the regulatory agency 104. In some instances, the format or content may also be based on one or more criteria of the buyer 106, such as entity type, business type, business size, etc. For example, the rules regarding electronic invoices for individuals may be different than for a business, and rules may vary for businesses based on their number of employees, transaction volume, revenue, etc.

In some embodiments, the processing server 102 may generate more than one electronic invoice for the payment transaction. For example, the processing server 102 may generate an electronic invoice for the regulatory agency 104 that includes data associated with the processing server 102 (e.g., certificate number, seal, etc.) and may generate a second electronic invoice for the buyer 106 that does not include the data associated with the processing server 102, but may include additional data as requested by the buyer 106 (e.g., a purchase order number for internal organizational use). The processing server 102 may electronically transmit the generated electronic invoice(s) to the regulatory agency 104 and/or the buyer 106 using a suitable communication network. In some embodiments, the processing server 102 may electronically transmit the electronic invoice to the buyer 106 for forwarding to the regulatory agency 104. In other embodiments, the processing server 102 may electronically transmit an electronic invoice directly to the regulatory agency 104. In some instances, transmission of the electronic invoice may be regulated by the regulatory agency 104.

In some embodiments, the processing server 102 may also generate and electronically transmit an electronic invoice to a financial institution 112 associated with the buyer 106. The financial institution 112 may be an issuing bank or other entity associated with the transaction account used by the buyer 106 to fund the payment transaction. The financial institution 112 may receive the electronic invoice for usage in internal record-keeping, auditing, or reporting of the electronic invoice to the regulatory agency 104. In some instances, a separate electronic invoice may be generated by the processing server 102 for the financial institution 112, such as to include additional data as requested by the financial institution 112. In embodiments where the processing server 102 may be configured to process payment transactions for the payment network 110, the processing server 102 may be configured to electronically transmit transaction messages to and receive transaction messages from the financial institution 112 via the payment rails as part of the processing of the payment transactions.

In some instances, the processing server 102 may be configured to generate electronically transmittable images for electronic invoices. Electronically transmittable images may be images that include the data included in an electronic invoice, in an image representation that may be viewable using a suitable computing device and/or system of the regulatory agency 104, buyer 106, seller 108, financial institution 112, etc. In such instances, the format and content of the image may be based on the entity to whom the image is being electronically transmitted (e.g., the regulatory agency 104 may have different requirements than the buyer 106) and may also be based on the rules or regulations set forth by the regulatory agency 104 (e.g., minimum requirements for any image representation of an electronic invoice).

In some embodiments, electronic invoices generated based on transaction messages that are authorization requests may be preliminary invoices. In such embodiments, a preliminary invoice may be electronically transmitted to the regulatory agency 104, buyer 106, etc. following the receipt of an authorization request by the processing server 102. When the processing server 102 receives a clearing record for the same payment transactions, the processing server 102 may electronically transmit a finalized electronic invoice based on the data included therein to the regulatory agency 104, buyer 106, etc. In some cases, the processing server 102 may electronically transmit a notification indicative of confirmation of the data included in the preliminary invoice, and may not transmit a second electronic invoice. In some instances, the processing server 102 may transmit a preliminary invoice to the buyer 106 and a finalized invoice (e.g., following receipt of the clearing record) to the regulatory agency 104.

The methods and systems discussed herein enable the processing server 102 to efficiently and accurately generate electronic invoices for payment transactions. By operating directly from transaction messages provided by the payment network 110, the electronic invoices may have a greater level of accuracy than traditional invoices that rely on data captured by the buyer 106 and reproduced to a third party entity. In addition, by operating directly using transaction messages, the processing server 102 can generate and report invoices without the need for interaction with the buyer 106 beyond registration. This can result in more efficient reporting of electronic invoices that requires less expenditure of both time and resources for buyers 106 and other entities.

### Processing Server

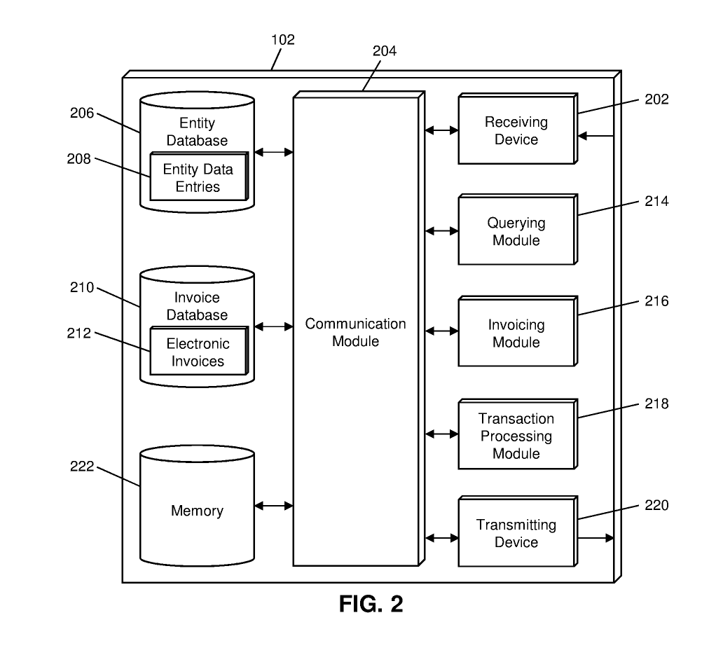

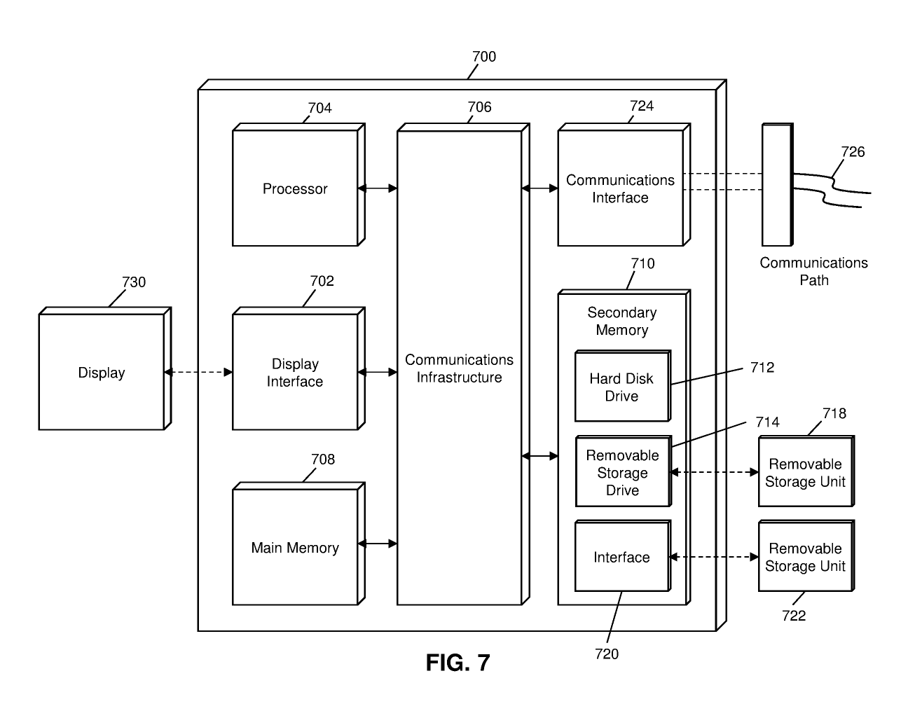

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 110 for the transmission of transaction messages that include sensitive financial data and information. In some instances, the receiving device 202 may also be configured to receive data from regulatory agencies 104, buyers 106, issuers 108, payment networks 110, financial institutions 112, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals from regulatory agency 104 that are superimposed with rules and regulations for use in generating and reporting electronic invoices. The receiving device 202 may also receive data signals from the regulatory agency 104 superimposed with electronic invoice requests, which may include data associated with an entity (e.g., the buyer 106) or one or more payment transactions (e.g., transaction identifiers, such as transaction identification numbers) for which electronic invoices are requested. The receiving device 202 may also receive data signals electronically transmitted by the buyer 106 that are superimposed with registration data associated with the buyer 106 for use in identifying transactions and generating electronic invoices, such as a transaction account number, tax identification number, and entity invoicing data. The receiving device 202 may also receive transaction messages for payment transactions from the payment network 110 via the payment rails or a suitable alternative communication network, which may include both authorization requests and/or responses and clearing records.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, invoicing module 216, and transaction processing module 218. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an entity database 206. The entity database 206 may be configured to store a plurality of entity data entries 208 using a suitable data storage format and schema. The entity database 206 may be a relational database that utilizes structured query language for the storage, identification, modifying, updating, accessing, etc. of structured data sets stored therein. Each entity data entry 208 may be a structured data set configured to store data related to a taxable entity (e.g., the buyer 106, seller 108, etc.), which may include at least a transaction account number, a tax identification number, and entity invoicing data. The transaction account number may be a number suitable for use in identification of an associated transaction account, such as may be included in a transaction message funded by the associated transaction account. The tax identification number may be an identification number issued to the taxable entity by the regulatory agency 104 or other agency suitable for use in identification of the taxable entity. The entity invoicing data may include additional data associated with the taxable entity that may be required by the processing server 102 and/or regulatory agency 104 for use in performing the functions discussed herein, such as an entity name, entity address, merchant category code, business organizational type, revenue, etc.

The processing server 102 may also include an invoice database 210. The invoice database 210 may be configured to store a plurality of electronic invoices 212 using a suitable data storage format and schema. The invoice database 210 may be a relational database that utilizes structured query language for the storage, identification, modifying, updating, accessing, etc. of structured data sets stored therein. The electronic invoices 212 may be structured data sets that include data associated with an electronic invoice generated by the processing server 102 using the processes discussed herein. Each electronic invoice may include data as set forth by the regulatory agency 104, buyer 106, and/or financial institution 112, and may vary depending on recipient (e.g., regulatory agency 104, buyer 106, financial institution 112, etc.) and type (e.g., preliminary based on authorization request, final based on clearing record, etc.) of the electronic invoice. In some instances, each electronic invoice 212 may also include additional data suitable for use by the processing server 102 in performing the functions discussed herein, such as relational data used to match electronic invoices 212 to entity data entries 208.

The querying module 214 of the processing server 102 may be configured to execute queries on databases to identify information. The querying module 214 may receive one or more data values or query strings, and may execute a query string based thereon on an indicated database, such as the entity database 206 or invoice database 210, to identify information stored therein. The querying module 214 may then output the identified information to an appropriate engine or module of the processing server 102 as necessary. The querying module 214 may, for example, execute a query on the entity database 206 to identify an entity data entry 208 associated with a taxable entity involved in a payment transaction, for use in generating an electronic invoice. The query may, for instance, identify the entity data entry 208 based on inclusion of a transaction account number that is included in a corresponding data element parsed from a transaction message received by the receiving device 202.

The invoicing module 216 of the processing server 102 may be configured to generate an electronic invoice for a payment transaction. The invoicing module 216 may receive at least a transaction message and/or data parsed therefrom (e.g., from the receiving device 202) related to a payment transaction as well as an entity data entry 208 and/or data included therein (e.g., from the querying module 214) associated with a taxable entity involved in the payment transaction and may generate an electronic invoice based thereon. The electronic invoice may also be generated based on additional data, such as rules and regulations, which may be stored in a database internal or external to the processing server 102 and/or received by the receiving device (e.g., in a data signal electronically transmitted by the regulatory agency 104).

In some embodiments, the invoicing module 216 may be configured to generate multiple electronic invoices for a single payment transaction. For example, the invoicing module 216 may generate an electronic invoice for the buyer 106 and for the regulatory agency 104 for a payment transaction. In such embodiments, the content and/or format of the electronic invoice may vary, and may be identified based on data included in the entity data entry 208 or one or more rules and/or algorithms stored in a database internal or external to the processing server 102 for use thereof, such as the memory 222, discussed below. The format and content of the electronic invoice may also be based on the type of the transaction message, such as if the transaction message is an authorization request or clearing record. In some embodiments, the invoicing module 216 may be configured to generate notifications and/or confirmations, such as to notify one or more entities of a payment transaction, preliminary invoice, receipt of a clearing record, changes to a preliminary invoice, confirmation of a preliminary invoice, etc.

In some embodiments, the processing server 102 may also include a transaction processing module 218. In embodiments where the processing server 102 may be part of the payment network 110, the transaction processing module 218 may be configured to process payment transactions. For instance, the transaction processing module 218 may be configured to analyze transaction data included in data elements of a transaction message for use in routing transaction messages, approving or denying transactions, scoring transactions for fraud, etc. In some instances, the transaction processing module 218 may determine if an electronic invoice needs to be generated for a received transaction message. For example, the transaction processing module 218 may identify the transaction account number stored in a corresponding data element of the transaction message and may pass the number to the querying module 214 to identify if a corresponding entity data entry 208 exists in the entity database 206. If it does, then the related taxable entity must be registered for electronic invoicing and the transaction message may be provided to the invoicing module 214. If there is no corresponding entity data entry 208, electronic invoicing may not be performed and the remainder of the payment transaction processed as usual.

The processing server 102 may further include a transmitting device 220. The transmitting device 220 may be configured to transmit data over one or more networks via one or more network protocols. In some embodiments, the transmitting device 220 may be configured to transmit data over the payment rails, such as using specially configured infrastructure associated with payment networks 110 for the transmission of transaction messages that include sensitive financial data and information, such as identified payment credentials. In some instances, the transmitting device 220 may be configured to transmit data to regulatory agencies 104, buyers 106, sellers 108, payment networks 110, financial institutions 112, and other entities via alternative networks, such as the Internet. In some embodiments, the transmitting device 220 may be comprised of multiple devices, such as different transmitting devices for transmitting data over different networks, such as a first transmitting device for transmitting data over the payment rails and a second transmitting device for transmitting data over the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals superimposed with electronic invoices to the regulatory agency 104, buyer 106, seller 108, financial institution 112, and other suitable entities using one or more suitable communication networks. The transmitting device 220 may also be configured to electronically transmit data signals superimposed with notifications, confirmations, alerts, etc. regarding electronic invoices. In some instances, the transmitting device 220 may be configured to make electronic invoices available for transmission to an outside entity via an application programming interface that may be accessed by computing systems of the outside entity, such as for the buyer 106 to access electronic invoices for associated payment transactions that are generated by the processing server 102.

The processing server 102 may also include a memory 222. The memory 222 may be configured to store data for use by the processing server 102 in performing the functions discussed herein. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

### Processes for Generating and Reporting an Electronic Invoice

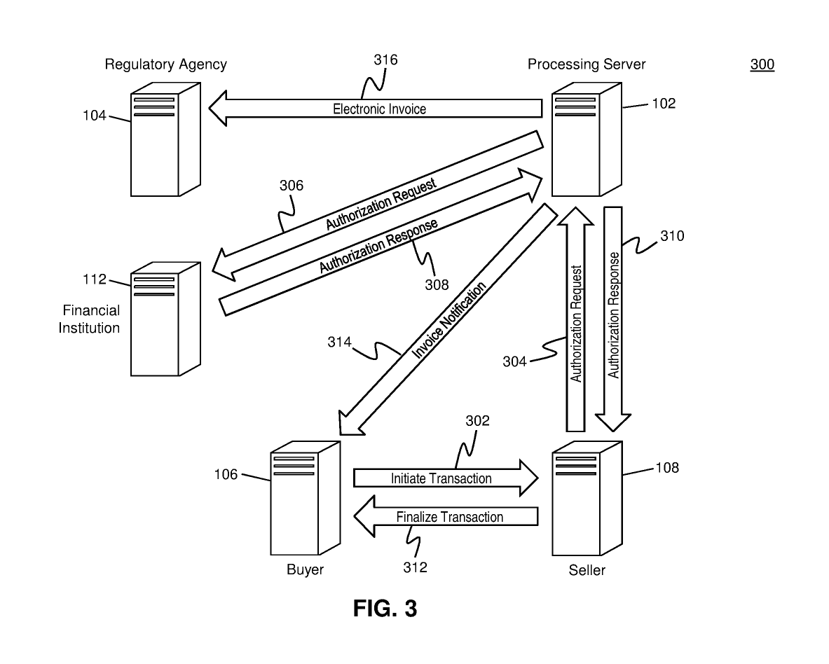

FIG. 3 illustrates a process 300 for the generation and reporting of an electronic invoice for a payment transaction based on transaction data included in a transaction message submitted to a payment network for the payment transaction using the system 100.

In step 302, the buyer 106 may initiate a payment transaction with the seller 108. As part of the initiation of the payment transaction, the buyer 106 may provide the seller 108 with payment credentials associated with a transaction account used to fund the payment transaction including at least a corresponding transaction account number. The payment credentials may be input into a computing system (e.g., a point of sale system) of the seller 108 along with additional transaction data related to the payment transaction. Additional transaction data may include, for example, a transaction amount, transaction time, transaction data, geographic location, merchant transaction account information, tax data, product data, point of sale data, reward data, loyalty data, offer data, etc.

In the process 300 illustrated in FIG. 3, the processing server 102 may be a part of the payment network 110 and configured to process payment transactions. In step 304, the seller 108 may submit an authorization request (e.g., via one or more intermediate entities) to the processing server 102 for processing of the payment transaction via the payment rails, which may be received by the receiving device 202 of the processing server 102. The authorization request may be a transaction message that is formatted based on one or more standards, such as the ISO 8583 standard, that includes a message type indicator indicating an authorization request and includes a plurality of data elements including a first data element configured to store the transaction account number included in the payment credentials provided by the buyer 106 and one or more additional data elements configured to store the additional transaction data. In step 306, the transaction processing module 218 of the processing server 102 may identify a financial institution 112 associated with the transaction account used to fund the transaction, such as based on one or more values included in the transaction account number parsed from the authorization request, and the transmitting device 220 of the processing server 102 may forward the authorization request to the identified financial institution 112 for approval.

The financial institution 112 may approve the payment transaction based on the authorization request using traditional methods and systems, and, in step 308, may return an authorization response to the processing server 102 via the payment rails. The authorization response may be a transaction message that includes the data included in the authorization request, and also including a message type indicator indicating an authorization response and a data element configured to store a response code indicating approval of the payment transaction. The receiving device 202 of the processing server 102 may receive the authorization response, which may, in step 310, be forwarded to the seller 108 (e.g., via one or more intermediate entities) via the payment rails by the transmitting device 220. In step 312, the seller 108 and buyer 106 may finalize the payment transaction, if approved by the financial institution 112, such as by the seller 108 furnishing the buyer 106 with transacted-for goods or services.

The invoicing module 216 of the processing server 102 may generate a preliminary invoice for the payment transaction based on the transaction data stored in the one or more additional data elements included in the authorization request and/or response and additional data, such as included in an entity data entry 208 associated with the buyer 106 as identified by the querying module 214 of the processing server 102 and data associated with the regulatory agency 104 as may be stored in the memory 222 of the processing server. In some instances, the preliminary invoice may be stored as an electronic invoice 212 in the invoice database 210. In step 314, the transmitting device 220 may electronically transmit a data signal to the buyer 106 using a suitable communication network that is superimposed with a notification indicating that a preliminary electronic invoice has been generated for the payment transaction. In some instances, the preliminary invoice may be electronically transmitted to the buyer 106, or otherwise made available to the buyer 106 (e.g., via a request electronically transmitted by the buyer 106 for the preliminary invoice).

Once the clearing record for the payment transaction has been received by the receiving device 202 of the processing server 102, the invoicing module 216 may generate a finalized electronic invoice for the payment transaction. In some instances, the finalized electronic invoice may be a newly generated electronic invoice based on the transaction data included in the clearing record. In other instances, the finalized electronic invoice may be the preliminary invoice with any necessary modifications made to the data included therein as based on any differences in the transaction data in the clearing record as compared to the transaction data in the authorization request. In such instances, the clearing record may be matched to the authorization request (e.g., and/or the associated preliminary invoice) based on the transaction data, such as using a transaction identification number or one or more data values included in the transaction data. The finalized electronic invoice may also include additional data suitable for use by the regulatory agency 104 in authenticating and/or validating the processing server 102, such as a certificate number or seal issued to the processing server 102 by the regulatory agency 104. In step 316, the finalized electronic invoice may be electronically transmitted to the regulatory agency 104 by the transmitting device 220 of the processing server 102 using a suitable communication network.

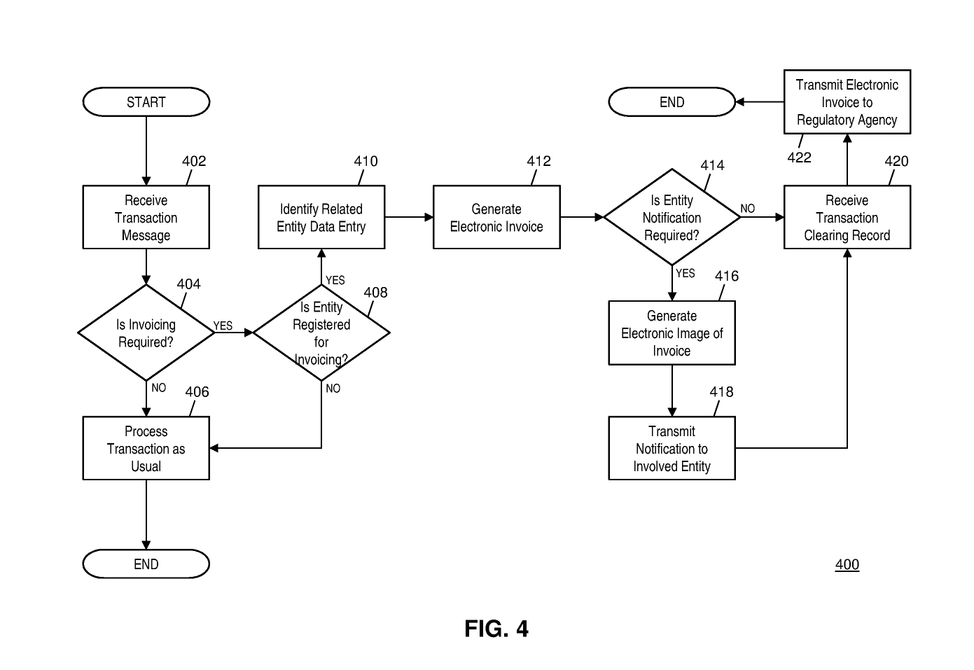

FIG. 4 illustrates a process 400 for the generation and reporting of an electronic invoice for a payment transaction to a regulatory agency 104 based on transaction data included in a transaction message as performed by the processing server 102.

In step 402, the receiving device 202 of the processing server 102 may receive a transaction message for a payment transaction. The transaction message may be received from the payment network 110 or another entity (e.g., the seller 108, an acquirer, a gateway processor, etc.) via the payment rails or via a suitable alternative communication network. The transaction message may be formatted based on one or more standards, such as the ISO 8583 standard, may be an authorization request, and may also include at least a first data element configured to store a primary account number and one or more additional data elements configured to store additional transaction data.

In step 404, the invoicing module 216 and/or the transaction processing module 218 of the processing server 102 may determine if electronic invoicing for the payment transaction is required. The determination may be made on multiple criteria, such as including registration of an entity involved in the payment transaction and compliance of the payment transaction with rules and regulations regarding electronic invoicing. For example, the invoicing module 216 may instruct the querying module 214 of the processing server 102 to execute a query on the entity database 206 to check for an entity data entry 208 that includes a transaction account number that corresponds to the primary account number stored in the first data element included in the received transaction message. If an entity data entry 208 exists, then the associated taxable entity may be involved in the payment transaction and registered for electronic invoicing. If an entity data entry 208 is not identified, then electronic invoicing may not be performed. Similarly, the invoicing module 216 and/or transaction processing module 218 may compare the additional transaction data stored in the one or more additional data elements to rules and regulations set forth by the regulatory agency 104 to determine if electronic invoicing is required. For instance, electronic invoicing may only be required by the regulatory agency 104 for transactions exceeding a specific amount, transactions related to specific industries, etc.

If the processing server 102 determines that electronic invoicing is not required, then, in step 406, the payment transaction may be processed as usual by the transaction processing module 218 and/or the payment network 110. If the processing server determines that electronic invoicing is required, then, in step 408, the processing server 102 may determine if the taxable entity involved in the transaction is registered for invoicing. The determination may be based on, for instance, the successful identification of an associated entity data entry 208 in the entity database 206 for the taxable entity (e.g., identified in step 404) and the determination of data therein regarding invoicing. For instance, a taxable entity may be registered with the processing server 102, but may not be registered for invoicing specifically. In another example, a taxable entity may be registered for invoicing only for specific transactions (e.g., with specific merchants, above specific transaction amounts, in specific geographic locations, etc.), and the determination in step 408 may involve determining if the taxable entity is registered for invoicing for the specific payment transaction. If the processing server 102 determines that the entity is not registered for invoicing for that transaction, then, in step 406, the payment transaction may be processed as usual by the transaction processing module 218 and/or the payment network 110.

If, in step 408, the processing server 102 determines that the taxable entity is registered for invoicing for the payment transaction, then, in step 410, the querying module 214 of the processing server 102 may execute a query on the entity database 206 to identify the entity data entry 208 and data included therein that includes a transaction account number corresponding to the primary account number stored in the first data element included in the transaction message. In step 412, the invoicing module 216 may generate a preliminary invoice for the payment transaction. The preliminary invoice may include data based on the transaction data stored in the one or more additional data elements included in the transaction message and the entity invoicing data stored in the identified entity data entry 208, and may also be based on and formatted pursuant to the rules and regulations set forth by the regulatory agency 104. In some instances, the preliminary electronic invoice may also include data associated with the processing server 102, such as a certificate number, seal, or other data issued to the processing server 102 by the regulatory agency 104.

In step 414, the processing server 102 may determine if the taxable entity associated with the entity data entry 208 is to be notified of the electronic invoice. The determination may be based on data included in the entity data entry 208, such as based on preferences provided by the taxable entity, such as during registration for the electronic invoicing service. If a notification is to be provided, then, in step 416, the invoicing module 216 may generate an electronically transmittable image of the preliminary invoice. In some instances, the electronically transmittable image may include only some of the data included in the electronic invoice, such as by not including the data associated with the processing server 102. In some cases, the electronically transmittable image may include additional data, such as based on the preferences provided by the taxable entity. In step 418, the transmitting device 220 of the processing server 102 may electronically transmit the generated image to the taxable entity using a suitable communication method.

Once the taxable entity has been notified, or if, in step 414, it is determined that the taxable entity does not need to be notified, then, in step 420, the receiving device 202 of the processing server 102 may receive the clearing record for the payment transaction. The clearing record may be a transaction message indicative of being a clearing record and including a plurality of data elements including transaction data, which may include the primary account number included in the earlier received transaction message, as well as a transaction identification number and/or other data suitable for use in matching the clearing record to the earlier received transaction message. The invoicing module 216 may generate a finalized version of the electronic invoice by performing any necessary modifications to the preliminary electronic invoice based on the data included in the clearing record. For example, the transaction amount for the payment transaction may have been modified between the authorization request and clearing record (e.g., due to a discount, gratuity, etc.) and the electronic invoice updated accordingly. In step 422, the transmitting device 220 may electronically transmit the updated, finalized electronic invoice to the regulatory agency 104 using a suitable communication network.

### Exemplary Method for Generating and Reporting Electronic Invoices for a Payment Transaction

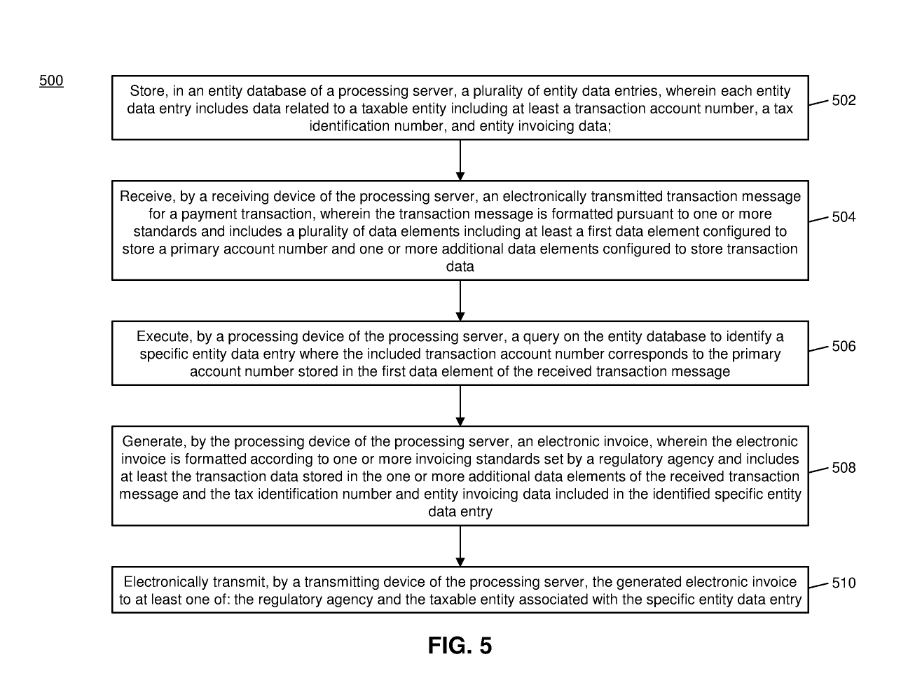

FIG. 5 illustrates a method 500 for the generation and reporting of electronic invoices for a payment transaction based on and including data captured from a transaction message associated with the payment transaction.

In step 502, a plurality of entity data entries (e.g., entity data entries 208) may be stored in an entity database (e.g., the entity database 206) of a processing server (e.g., the processing server 102), wherein each entity data entry includes data related to a taxable entity including at least a transaction account number, a tax identification number, and entity invoicing data. In step 504, an electronically transmitted transaction message for a payment transaction may be received by a receiving device (e.g., the receiving device 202) of the processing server, wherein the transaction message is formatted pursuant to one or more standards and includes a plurality of data elements including at least a first data element configured to store a primary account number and one or more additional data elements configured to store transaction data.

In step 506, a processing device (e.g., the querying module 214 of a processing device) of the processing server may execute a query on the entity database to identify a specific entity data entry where the included transaction account number corresponds to the primary account number stored in the first data element of the received transaction message. In step 508, an electronic invoice may be generated by the processing device (e.g., the invoicing module 216 of the processing device) of the processing server, wherein the electronic invoice is formatted according to one or more invoicing standards set by a regulatory agency (e.g., the regulatory agency 104) and includes at least the transaction data stored in the one or more additional data elements of the received transaction message and the tax identification number and entity invoicing data included in the identified specific entity data entry.

In step 510, the generated electronic invoice may be electronically transmitted by a transmitting device (e.g., the transmitting device 220) of the processing server to at least one of: the regulatory agency and the taxable entity associated with the specific data entry. In one embodiment, the method 500 may further include receiving, by the receiving device of the processing server, a clearing record for the payment transaction, wherein the electronic invoice is transmitted subsequent to receipt of the clearing record.

In some embodiments, the method 500 may also include electronically transmitting, by the transmitting device of the processing server, a notification to the taxable entity related to the identified specific entity data entry indicative of generation of the electronic invoice. In a further embodiment, the notification may be transmitted prior to transmission of the electronic invoice. In another further embodiment, the method 500 may even further include generating, by the processing device of the processing server, an electronically-transmittable image of the generated electronic invoice using one or more computer-implemented imaging techniques, wherein the notification comprises the generated electronically-transmittable image.

In one embodiment, the received transaction message may include a message type indicator indicative of an authorization response. In other embodiments, the received transaction message may include a message type indicator indicative of an authorization request. In a further embodiment, the method 500 may also include: electronically transmitting, by the transmitting device of the processing server, the received transaction message to a financial institution (e.g., the financial institution 112) associated with the taxable entity related to the identified specific entity data entry; and receiving, by the receiving device of the processing server, a second transaction message from the financial institution that includes a message type indicator indicative of an authorization response. In a further embodiment, the received second transaction message may include a response code indicative of approval of the payment transaction. In an even further embodiment, the second transaction message may be received prior to generation of the electronic invoice.

### Payment Transaction Processing System and Process

FIG. 6 illustrates a transaction processing system and a process 600 for the processing of payment transactions in the system. The process 600 and steps included therein may be performed by one or more components of the system 100 discussed above, such as the processing server 102, buyer 104, seller 108, payment network 110, financial institution 112, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicate electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution 610 may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 650, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for generating and reporting electronic invoices for a payment transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for generating and reporting electronic invoices for a payment transaction, comprising:
storing, in an entity database of a processing server, a plurality of entity data entries, wherein each entity data entry includes data related to a taxable entity including at least a transaction account number, a tax identification number, and entity invoicing data;
receiving, by a receiving device of the processing server, an electronically transmitted transaction message for a payment transaction, wherein the transaction message is formatted pursuant to one or more standards and includes a plurality of data elements including at least a first data element configured to store a primary account number and one or more additional data elements configured to store transaction data;
executing, by a processing device of the processing server, a query on the entity database to identify a specific entity data entry where the included transaction account number corresponds to the primary account number stored in the first data element of the received transaction message;
generating, by the processing device of the processing server, an electronic invoice, wherein the electronic invoice is formatted according to one or more invoicing standards set by a regulatory agency and includes at least the transaction data stored in the one or more additional data elements of the received transaction message and the tax identification number and entity invoicing data included in the identified specific entity data entry; and
electronically transmitting, by a transmitting device of the processing server, the generated electronic invoice to at least one of: the regulatory agency and the taxable entity associated with the specific entity data entry.

2. The method of claim 1, further comprising:
receiving, by the receiving device of the processing server, a clearing record for the payment transaction, wherein the electronic invoice is transmitted subsequent to receipt of the clearing record.

3. The method of claim 1, further comprising:
electronically transmitting, by the transmitting device of the processing server, a notification to the taxable entity related to the identified specific entity data entry indicative of generation of the electronic invoice.

4. The method of claim 3, wherein the notification is transmitted prior to transmission of the electronic invoice.

5. The method of claim 3, further comprising:
generating, by the processing device of the processing server, an electronically-transmittable image of the generated electronic invoice using one or more computer-implemented imaging techniques, wherein the notification comprises the generated electronically-transmittable image.

6. The method of claim 1, wherein the received transaction message includes a message type indicator indicative of an authorization response.

7. The method of claim 1, wherein the received transaction message includes a message type indicator indicative of an authorization request.

8. The method of claim 7, further comprising:
electronically transmitting, by the transmitting device of the processing server, the received transaction message to a financial institution associated with the taxable entity related to the identified specific entity data entry; and
receiving, by the receiving device of the processing server, a second transaction message from the financial institution that includes a message type indicator indicative of an authorization response.

9. The method of claim 8, wherein the received second transaction message includes a response code indicative of approval of the payment transaction.

10. The method of claim 9, wherein the second transaction message is received prior to generation of the electronic invoice.

11. A system for generating and reporting electronic invoices for a payment transaction, comprising:
an entity database of a processing server configured to store a plurality of entity data entries, wherein each entity data entry includes data related to a taxable entity including at least a transaction account number, a tax identification number, and entity invoicing data;
a receiving device of the processing server configured to receive an electronically transmitted transaction message for a payment transaction, wherein the transaction message is formatted pursuant to one or more standards and includes a plurality of data elements including at least a first data element configured to store a primary account number and one or more additional data elements configured to store transaction data;
a processing device of the processing server configured to
execute a query on the entity database to identify a specific entity data entry where the included transaction account number corresponds to the primary account number stored in the first data element of the received transaction message, and
generate an electronic invoice, wherein the electronic invoice is formatted according to one or more invoicing standards set by a regulatory agency and includes at least the transaction data stored in the one or more additional data elements of the received transaction message and the tax identification number and entity invoicing data included in the identified specific entity data entry; and
a transmitting device of the processing server configured to electronically transmit the generated electronic invoice to at least one of: the regulatory agency and the taxable entity associated with the specific entity data entry.

12. The system of claim 11, wherein the receiving device of the processing server is further configured to receive a clearing record for the payment transaction, wherein the electronic invoice is transmitted subsequent to receipt of the clearing record.

13. The system of claim 11, wherein the transmitting device of the processing server is further configured to electronically transmit a notification to the taxable entity related to the identified specific entity data entry indicative of generation of the electronic invoice.

14. The system of claim 13, wherein the notification is transmitted prior to transmission of the electronic invoice.

15. The system of claim 13, wherein the processing device of the processing server is further configured to generate an electronically-transmittable image of the generated electronic invoice using one or more computer-implemented imaging techniques, wherein the notification comprises the generated electronically-transmittable image.

16. The system of claim 11, wherein the received transaction message includes a message type indicator indicative of an authorization response.

17. The system of claim 11, wherein the received transaction message includes a message type indicator indicative of an authorization request.

18. The system of claim 17, wherein
the transmitting device of the processing server is further configured to electronically transmit the received transaction message to a financial institution associated with the taxable entity related to the identified specific entity data entry, and
the receiving device of the processing server is further configured to receive a second transaction message from the financial institution that includes a message type indicator indicative of an authorization response.

19. The system of claim 18, wherein the received second transaction message includes a response code indicative of approval of the payment transaction.

20. The system of claim 19, wherein the second transaction message is received prior to generation of the electronic invoice.
